(19) United States
(12) Patent Application Publication
(10) Pub. No.: US 2007/0216609 A1
(43) Pub. Date: Sep. 20, 2007

(54) Apparatus and method of driving plasma display panel

(76) Inventors: Jung-Pil Park, Suwon-si (KR); Jae-Kwang Lim, Suwon-si (KR); Byung-Tae Choi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/712,864

(22) Filed: Mar. 1, 2007

(30) Foreign Application Priority Data
Mar. 14, 2006 (KR) 10-2006-0023515

(51) Int. Cl. G09G 3/28

(52) U.S. Cl. 345/68

(57) ABSTRACT

An apparatus for driving a plasma display panel is disclosed. In one embodiment, the apparatus includes i) first and second electrodes configured to generate a sustain discharge in a frame which includes a plurality of subfields and ii) a driver configured to provide a series of driving pulses to at least one of the first and second electrodes in at least one of the plurality of subfields. At least the last one of the series of driving pulses has a greater rising and/or falling time than those of the remaining driving pulses. According to at least one embodiment, the rising or falling time of the last one or several sustain pulse(s) applied to sustain electrodes during a sustain discharge period of one or more subfields is adjusted to be greater than those of the other sustain pulses, thereby reducing the appearance of an afterimage.

### CROSS-REFERENCE TO RELATED PATENT APPLICATION

This application claims the benefit of Korean Patent Application No. 10-2006-0023515, filed on Mar. 14, 2006, in the Korean Intellectual Property Office, the disclosure of which is incorporated herein in its entirety by reference.

### BACKGROUND OF THE INVENTION

1. Field of the Invention

The present invention relates to an apparatus and method of driving a plasma display panel, and more particularly, to an apparatus and method of driving a display panel, in which a frame is divided into a plurality of sub-fields for achieving time-division gray level display, and each of the subfields includes a reset period, an addressing period, and a sustain discharge period.

2. Description of the Related Technology

Plasma display panels (PDPs) which are easily manufactured in a large size are flat panel displays. PDPs, which display an image using a discharge phenomenon, are typically classified into a direct current (DC) type and an alternating current (AC) type according to the type of a driving voltage. Due to long delay of a discharge time, AC PDPs are actively being developed.

3-electrode AC surface-discharge PDPs that include 3 electrodes and are driven with an AC voltage are representative as AC PDPs. General 3-electrode AC surface-discharge PDPs include multiple plates and are advantageous in terms of the space because they are thin and light and still provide large screens.

A typical 3-electrode AC surface-discharge PDP and an apparatus and method of driving the PDP are disclosed in U.S. Pat. No. 6,744,218, to the applicant of the present invention, which is incorporated by reference. The PDP includes a plurality of display cells formed in regions where sustain electrodes intersect address electrodes. Each of the display cells includes three discharge cells, namely, red, green, and blue discharge cells, and represents the gray levels of images by adjusting the discharge states of the discharge cells.

To represent the gray levels of the PDP, a frame applied to the PDP includes, for example, 8 subfields providing different durations of light-emissions, so that 256 gray levels are represented. In other words, when an image is displayed with 256 gray levels, a frame period (i.e., 16.67 ms) corresponding to 1/60 second is divided into 8 subfields. Each of the subfields includes a rest period, an addressing period, and a sustain discharge period so as to drive the PDP. In the reset period, all of the discharge cells are initialized. In the addressing period, some of the discharge cells that are to be displayed are selected. In the sustain discharge period, display discharge is generated in the discharge cells selected during the addressing period.

Display of brightness in each of the discharge cells is made by sustain discharge generated during the sustain discharge period. In the sustain discharge period, sustain discharge depending on the number of sustain pulses depending on a gray level weight is generated. To generate sustain discharge, a pulse voltage that has a regular pattern and is greater than a discharge initiation voltage of a discharge gas is applied to alternate sustain electrodes within the discharge cells.

When the amount of light and the peak value thereof in such sustain discharge are sufficiently large, an afterimage may be generated. This may degrade the quality of an image displayed on the PDP.

### SUMMARY OF CERTAIN INVENTIVE ASPECTS

One aspect of the invention provides an apparatus for driving a plasma display panel, comprising: i) first and second electrodes configured to generate a sustain discharge in a frame which includes a plurality of subfields and ii) a driver configured to provide a series of driving pulses to at least one of the first and second electrodes in at least one of the plurality of subfields, wherein at least the last one of the series of driving pulses has a greater rising and/or falling time than those of the remaining driving pulses.

Another aspect of the invention provides an apparatus for driving a plasma display panel (PDP), comprising: a driver configured to drive the PDP and including first and second current paths, wherein the first and second current paths include first and second inductive loads, respectively, wherein the first and second inductive loads are different from each other, and wherein the first and second inductive loads are electrically connected to each other.

Still another aspect of the invention provides a method of driving a plasma display panel, comprising: i) generating at least one first driving pulse having a first rising and/or falling time, ii) generating at least one second driving pulse having a second rising and/or falling time which is longer than the first rising and/or falling time and iii) driving the PDP panel in a subfield of a frame with the combination of the first and second driving pulses.

### BRIEF DESCRIPTION OF THE DRAWINGS

Embodiments of the present invention will be described with reference to the attached drawings.

FIG. 1 is a perspective view showing a 3-electrode surface-discharge plasma display panel (PDP).

FIG. 2 is a block diagram schematically illustrating an apparatus for driving a PDP, according to an embodiment.

FIG. 3 is a timing diagram of an embodiment of driving signals that are output by driving units shown in FIG. 2.

FIG. 4 is a schematic timing diagram of sustain pulses in the driving signal of FIG. 3 that are applied during a sustain discharge period.

FIG. 5 is a timing diagram schematically illustrating the sustain pulse of the driving signal of FIG. 3 and control signals of driving switches for forming the sustain pulse.

FIG. 6 is a circuit diagram of an X driving unit in the PDP driving apparatus shown in FIG. 2.

FIG. 7 is a circuit diagram of a Y driving unit in the PDP driving apparatus shown in FIG. 2.

FIG. 8 is a timing diagram of another embodiment of driving signals that are output by driving units shown in FIG. 2.

FIG. 9 is a schematic timing diagram of sustain pulses in the driving signal of FIG. 9 that are applied during a sustain discharge period. FIG. 10 is a circuit diagram schematically illustrating an apparatus for driving a PDP according to the driving method of FIG. 8.

FIG. 11 is a schematic diagram of an inductor circuit which can be applied to FIGS. 6, 7 and 10 according to another embodiment.

### DETAILED DESCRIPTION OF CERTAIN INVENTIVE EMBODIMENTS

Certain embodiments will now be described more fully with reference to the accompanying drawings, in which exemplary embodiments of the invention are shown.

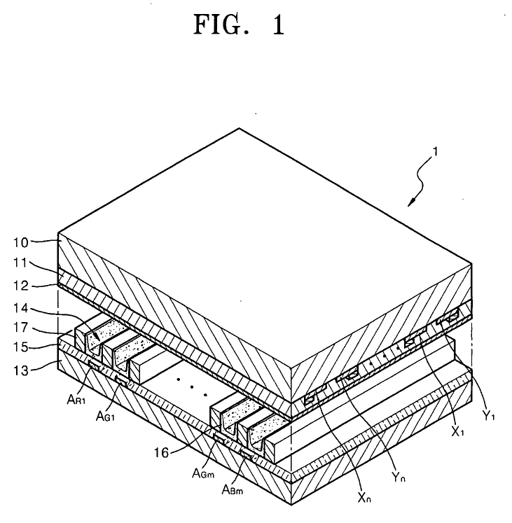

FIG. 1 is a perspective view showing a 3-electrode surface-discharge plasma display panel (PDP) 1. Referring to FIG. 1, the surface-discharge PDP 1 includes a front glass substrate 10, a rear glass substrate 13, address electrode lines AR1 through ABm, dielectric layers 11 and 15, Y electrode lines Y1 through Yn, X electrode lines X1 through Xn, phosphor layers 16, barrier ribs 17, and an MgO layer 12 as a protective layer. The address electrode lines AR1 through Abm, the dielectric layers 11 and 15, the Y electrode lines Y1 through Yn, the X electrode lines X1 through Xn, the phosphor layers 16, the barrier ribs 17, and the MgO layer 12 are interposed between the front and rear glass substrates 10 and 13.

The address electrode lines AR1 through ABm are arranged in a certain pattern in front of the rear glass substrate 13. The dielectric layer 15 covers the entire surface of the address electrode lines AR1 through ABm. In front of the dielectric layer 15, the barrier ribs 17 are arranged parallel to the address electrode lines AR1 through ABm. The barrier ribs 17 define the discharge regions of discharge cells 14 and prevent optical crosstalk between adjacent discharge cells 14. The phosphor layers 16 are formed within spaces defined by the dielectric layer 15 and barrier ribs 17.

The Y electrode lines Y1 through Yn and the X electrode lines X1 through Xn are arranged in a certain pattern at rear of the front glass substrate 10 and intersect the address electrode lines AR1 through ABm. The intersections create the discharge cells 14. Each of the Y electrode lines Y1 through Yn and the X electrode lines X1 through Xn includes a transparent electrode line formed of a transparent conductive material, such as, indium tin oxide (ITO), and a metal electrode line for increasing the conductivity. In each of the discharge cells 14, the X electrode lines X1 through Xn serve as sustain electrodes, the Y electrode lines Y1 through Yn serve as scan electrodes, and the address electrode lines AR1 through ABm serve as address electrodes.

Here, the Y electrode lines Y1 through Yn are scan electrodes to which scan pulses are sequentially applied in order to select discharge cells where an image is to displayed.

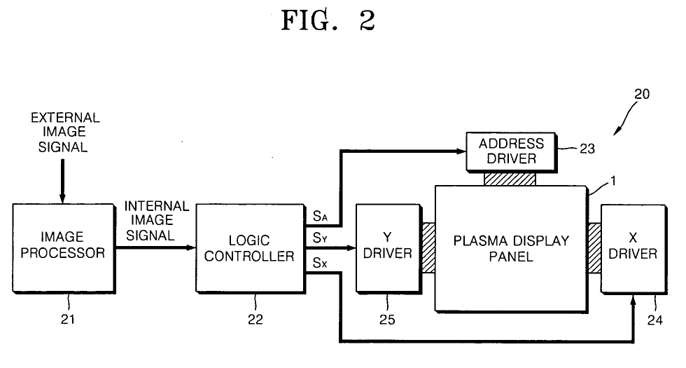

FIG. 2 is a block diagram schematically illustrating an apparatus 20 for driving the PDP 1, according to an embodiment. Referring to FIG. 2, the apparatus 20 for driving the PDP 1 includes an image processing unit 21, a logic control unit 22, an address driving unit 23, an X driving unit 24, and a Y driving unit 25. The image processing unit 21 converts an external analog image signal into a digital signal so as to generate internal image signals. The internal image signals may be, for example, 8-bit red (R) image data, 8-bit green (G) image data, 8-bit blue (B) image data, a clock signal, vertical and horizontal synchronization signals, etc. The logic control unit 22 generates driving control signals SA, SY, and SX according to the internal image signals of the image processing unit 21.

The address driving unit 23, the X driving unit 24, and the Y driving unit 25 receive the driving control signals SA, SY, and SX, generate respective driving signals, and apply the driving signals to their respective electrode lines.

Accordingly, the address driving unit 23 receives the address signal SA from the logic control unit 22, generates a display data signal depending on the address signal SA, and applies the display data signal to the address electrode lines AR1 through ABm. The X driving unit 24 processes the X driving control signal SX received from the logic control unit 22 and applies the processed X driving control signal Sx to the X electrode lines X1 through Xn. The Y driving unit 25 processes the Y driving control signal SY received from the logic control unit 22 and applies the processed Y driving control signal SY to the Y electrode lines Y1 through Yn.

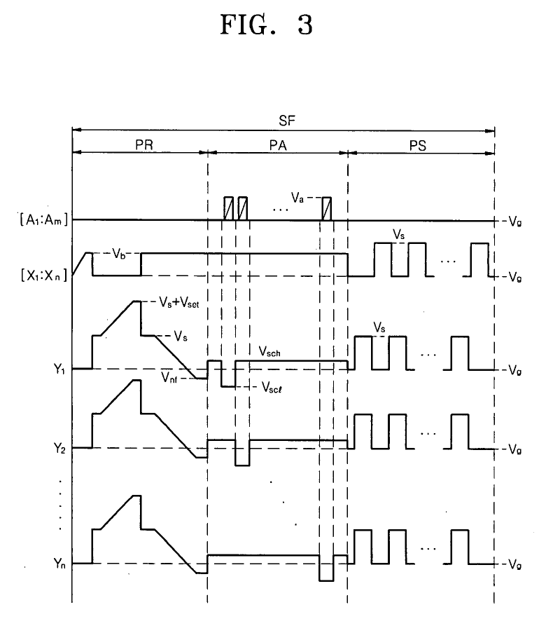

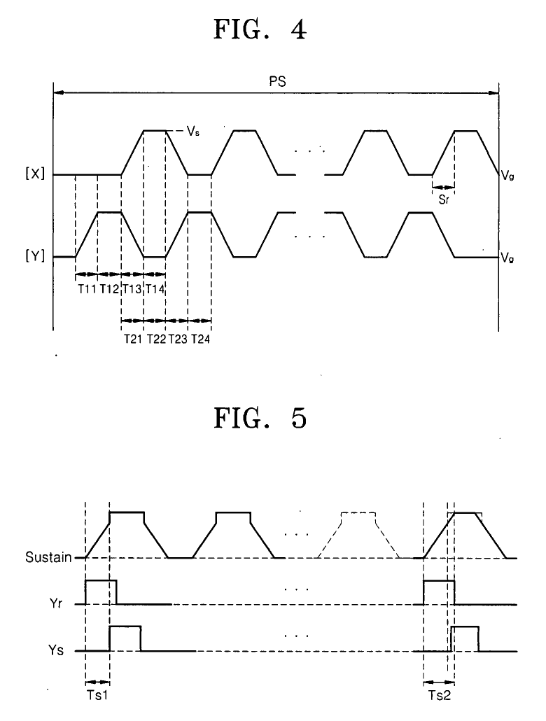

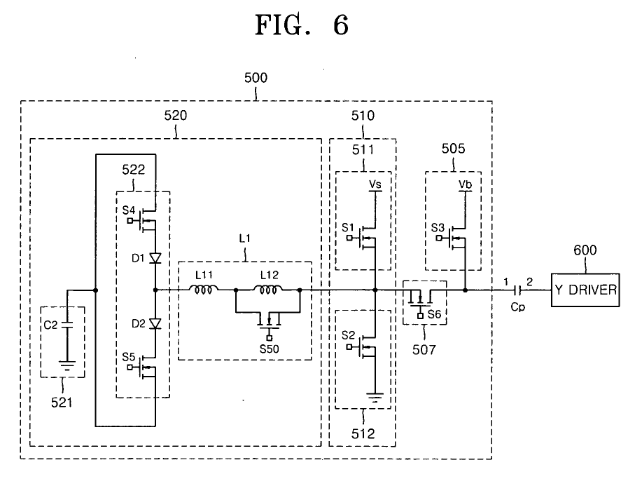

FIG. 3 is a timing diagram of an example of a driving signal that is output by each of the driving units shown in FIG. 2. FIG. 4 is a schematic timing diagram of sustain pulses in the driving signal of FIG. 3 that are applied during a sustain discharge period. FIG. 5 is a timing diagram schematically illustrating the sustain pulses of the driving signal of FIG. 3 and control signals of driving switches for forming the sustain pulse.

A unit frame is divided into a plurality of subfields SFs depending on a gray level weight for driving time-division gray level display. Each of the subfields SFs is divided into a reset period PR, an addressing period PA, and a sustain period PS.

During the reset period PR, a reset pulse including a rising edge and a falling edge is applied to the Y electrode lines Y1 through Yn, and a second voltage (i.e., a bias voltage) is applied to the X electrode lines X1 through Xn. Accordingly, reset discharge is performed during the reset period PR. All of the discharge cells may be initialized by reset discharge. The rising edge of the reset pulse rises by a rising voltage Vset from a sustain discharge voltage Vs and reaches a maximum rising voltage (Vset+Vs). The falling edge of the reset pulse falls from the sustain discharge voltage Vs and reaches a minimum falling voltage Vnf.

During the addressing period PA, scan pulses are sequentially applied to the Y electrode lines Y1 through Yn, and a display data signal is applied to address electrode lines A1 through Am in synchronization with the scan pulses. Hence, address discharge is performed during the addressing period PA. Discharge cells where sustain discharge generated during the sustain period PS is to be performed are selected by the address discharge. The scan pulses start with a scan high voltage Vsch and then sequentially have a scan low voltage Vsc1 less than the scan high voltage Vsch. The display data signal has a positive address voltage Va in synchronization with application of the scan low voltage Vsc1 of the scan pulse.

During the sustain period PS, sustain pulses having a voltage Vs are alternately applied to the X electrode lines X1 through Xn and the Y electrode lines Y1 through Yn. In one embodiment, the last one of the sustain pulses, either in each subfield or at least one particular subfield, has a greater rising and/or falling time than that (or those) of the remaining sustain pulses. In another embodiment, the last several sustain pulses have a greater rising and/or falling time than that (or those) of the remaining sustain pulses. This may apply to the remaining embodiments.

For example, the length Sr of a rising interval of the finishing (last) sustain pulse is greater than those of the rising intervals of the sustain pulses other than the finishing sustain pulse in each subfield.

In this embodiment, a sustain pulse is first applied to the Y electrode lines Y1 through Yn, and a sustain pulse is then applied to the X electrode lines X1 through Xn. Sustain pulses are alternately applied to the X electrode lines X1 through Xn and the Y electrode lines Y1 through Yn. The finishing sustain pulse is applied to the X electrode lines X1 through Xn. In another embodiment, the finishing sustain pulse may be applied to the Y electrode lines Y1 through Yn. In one embodiment, the finishing sustain pulse may be the last one or several pulses applied to the X electrode lines X1 through Xn and the Y electrode lines Y1 through Yn.

Each of the sustain pulses applied to the Y electrode lines Y1 through Yn includes a rising time T11, a first sustain time T12, a falling time T13, and a second sustain time T14. A voltage applied to the Y electrode lines Y1 through Yn during the rising time T11 rises from the first level Vg to the second level Vs. A voltage applied to the Y electrode lines Y1 through Yn during the first sustain time T12 sustains the second level Vs. A voltage applied to the Y electrode lines Y1 through Yn during the falling time T13 falls from the second level Vs to the first level Vg. A voltage applied to the Y electrode lines Y1 through Yn during the second sustain time T14 sustains the first level Vg.

Each of the sustain pulses applied to the X electrode lines X1 through Xn includes a rising time T21, a first sustain time T22, a falling time T23, and a second sustain time T24. A voltage applied to the X electrode lines X1 through Xn during the rising time T21 rises from the first level Vg to the second level Vs. A voltage applied to the X electrode lines X1 through Xn during the first sustain time T22 sustains the second level Vs. A voltage applied to the X electrode lines X1 through Xn during the falling time T23 falls from the second level Vs to the first level Vg. A voltage applied to the X electrode lines X1 through Xn during the second sustain time T24 sustains the first level Vg.

The rising time T11 of a sustain pulse applied to the Y electrode lines Y1 through Yn is overlapped by the falling time T23 of a previous sustain pulse applied to the X electrode lines X1 through Xn. The falling time T13 of a sustain pulse applied to the Y electrode lines Y1 through Yn is overlapped by the rising time T21 of a next sustain pulse applied to the X electrode lines X1 through Xn.

According to some embodiments, by lengthening the rising and/or falling time of the last one or several sustain pulse(s) in a subfield having at least two sustain pulses, the amount and peak value of light within the subfield are reduced. In particular, the amount and peak value of light of the last sustain pulse in the present subfield are reduced, which contributes to minimizing an influence between adjacent subfields or adjacent frames. Thus, appearance of afterimages is reduced, thus improving the quality of an image displayed by a PDP.

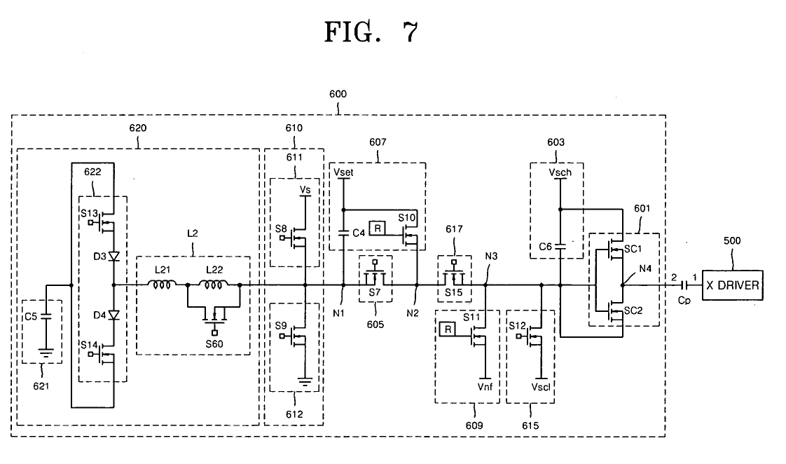

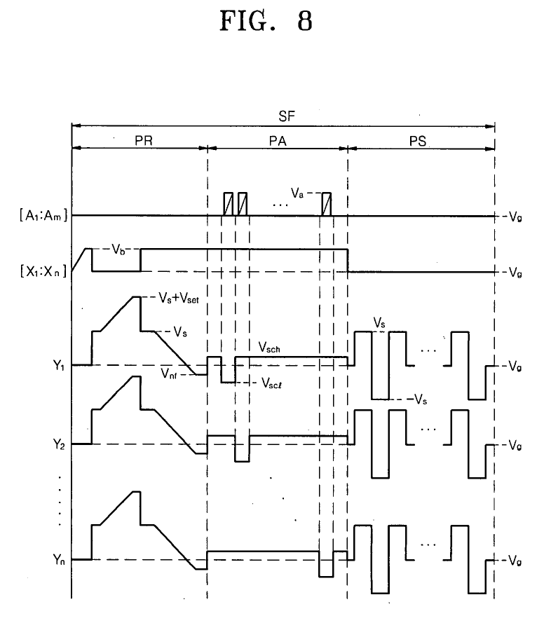

Referring to FIG. 5, the timing of consecutively rising edges from the first level Vg to the second level Vs due to a resonance current using an energy stored in an energy collection capacitor (i.e., a capacitor C2 of FIG. 6 or a capacitor C5 of FIG. 7) is controlled, so that the rising and/or falling time of a sustain pulse is lengthened.

During the rising edge of a sustain pulse, a first control switch (i.e., a fourth switching device S4 of FIG. 6 or a thirteenth switching device S13 of FIG. 7) is first turned on and, after a predetermined time interval Ts1, a third control switch (i.e., a first switching device S1 of FIG. 6 or an eighth switching device S8 of FIG. 7) is then turned on. A time interval Ts2 of the finishing sustain pulse is greater than the time interval Ts1 in sustain pulses other than the finishing sustain pulse. Hence, longer rising time is given to the finishing sustain pulse than to the other sustain pulses.

Driving signals other than those illustrated in FIG. 3 may be output by the driving units 23, 24, and 25 of FIG. 2.

FIG. 6 is a circuit diagram of an X driving unit 500, which is an embodiment of the X driving unit 25 of the PDP driving apparatus 20 shown in FIG. 2. Referring to FIG. 6, the X driving unit 500 of the PDP driving apparatus 20 includes a sustain pulse applying unit 510, a second voltage applying unit 505, an energy collecting unit 520, and a switching unit 507.

The sustain pulse applying unit 510 includes a first voltage applying unit 511 outputting a first voltage Vs and a ground voltage applying unit 512 outputting a ground voltage Vg, in order to output a driving signal to the X electrodes, namely, to a first end of a display panel Cp. The second voltage applying unit 505 outputs the second voltage Vb. The energy collecting unit 520 provides charges to the display panel Cp so that the charges are accumulated within the display panel Cp, or receives charges from the display panel Cp and stores the same therein.

The first voltage applying unit 511 includes a first switching device S1 with one end connected to a first voltage source Vs and the other end connected to the switching unit 507. The ground voltage applying unit 512 includes a second switching device S2 with one end grounded and the other end connected to the switching unit 507. In the sustain pulse applying unit 510 including the first voltage applying unit 511 and the ground voltage applying unit 512, the first and second switching devices S1 and S2 are alternately turned on in order to generate sustain pulses.

The second voltage applying unit 505 includes a third switching device S3 with one end connected to a second voltage source Vb and the other end connected to the X electrodes (i.e., the first end of the display panel Cp) of a PDP and to the switching unit 507. The third switching device S3 is turned on so that the second voltage Vb is output to the X electrodes (i.e., the first end of the display panel Cp) of the PDP.

The energy collection unit 520 includes an energy storage unit 521, an energy collection switching unit 522, and an inductor L1. The energy storage unit 521 stores charges existing within the display panel Cp. The energy collection switching unit 522 is connected to the energy storage unit 521 and controls the charges stored in the energy storage unit 521 to be accumulated within the display panel Cp or the charges within the display panel Cp to be stored in the energy storage unit 521. The inductor L1 has one end connected to the energy collection switching unit 522 and the other end connected to the X electrodes (i.e., the first end of the display panel Cp) of the PDP.

The energy storage unit 521 includes a capacitor C2 to store charges existing within the display panel. The energy collection switching unit 522 includes a fourth switching device S4 and a fifth switching device S5, each having one end connected to a ground terminal through capacitor C2 and the other end connected to the inductor L1 through respective diodes. A first diode D1 and a second diode D2 that have different directions may be connected between the fourth and fifth switching devices S4 and S5.

In an operation of the energy collection unit 520, when the fifth switching device S5 of the energy collection switching unit 522 is turned on, the charges within the display panel pass through the inductor L1, the second diode D2, and the fifth switching device S5 and are stored in the second capacitor C2. When the fourth switching device S4 of the energy collection switching unit 522 is turned on, the charges stored in the second capacitor C2 pass through the fourth switching device S4, the first diode D1, and the inductor L1 and are accumulated in the display panel Cp.

The inductor L1 includes a first inductor L11, a second inductor L12, and a control switch S50. The first and second inductors L11 and L12 are serially connected to each other. The control switch S50 is connected between both ends of the first or second inductor L11 or L12 so as to be parallel to one of the first and second inductors L11 and L12. In one embodiment, the control switch S50 is connected between both ends of the second inductor L12.

Accordingly, when the control switch S50 is turned on, the inductor L1 has an effect where only the first inductor L11 is connected to the energy collection switching unit 522. When the control switch S50 is turned off, the inductor L1 has an effect where a single inductor having an inductance value of the serial connection between the first and second inductors L11 and L12 is connected thereto.

A period of a resonance current flowing through an inductor is proportional to the inductance of the inductor. Accordingly, when the control switch S50 is turned off, the inductance of the inductor L1 is a sum of the first and second inductors L11 and L12, so that the rising time increases.

The switching unit 507 includes a sixth switching device S6 that has one end connected to the sustain pulse applying unit 510 and the other end connected to the second voltage applying unit 505 and the X electrodes of the display panel Cp (i.e., the first end thereof). The switching unit 507 performs a switching operation in order to apply sustain pulses output by the sustain pulse applying unit 510 to the X electrodes of the display panel and performs another switching operation to prevent the second voltage Vb output by the second voltage applying unit 505 from flowing into the sustain pulse applying unit 510. In other words, the sixth switching device S6 is turned on in order to apply the sustain pulses to the X electrodes of the display panel Cp, and is turned off in order to prevent the sustain pulses from flowing into the sustain pulse applying unit 510.

FIG. 7 is a circuit diagram of a Y driving unit 600, which is an embodiment of the Y driving unit 25 in the PDP driving apparatus 20 shown in FIG. 2. Referring to FIG. 7, the Y driving unit 600 of the PDP driving apparatus 20 includes a sustain pulse applying unit 610, a first switching unit 605, a second switching unit 617, a third voltage applying unit 607, a fourth voltage applying unit 609, a scan switching unit 601, a fifth voltage applying unit 603, a sixth voltage applying unit 615, and an energy collecting unit 620.

The sustain pulse applying unit 610 includes a first voltage applying unit 611 and a ground voltage applying unit 612. The first voltage applying unit 611 outputs a first voltage Vs to a first node N1 in order to output a driving signal to Y electrodes, namely, a second end of the display panel Cp. The ground voltage applying unit 612 outputs a ground voltage Vg to the first node N1.

The first switching unit 605 includes a seventh switching device S7 with one end connected to the first node N1 and the other end connected to a second node N2. The second switching unit 617 includes a fifteenth switching device S15 with one end connected to the second node N2 and the other end connected to a third node N3.

The third voltage applying unit 607 is connected between the first and second nodes N1 and N2 and gradually increases the first voltage Vs by a third voltage Vset and outputs the increased voltage to the second node N2. The fourth voltage applying unit 609 is connected to a third node N3 and gradually decreases the first voltage Vs to a fourth voltage Vnf and outputs the decreased voltage to the third node N3.

The scan switching unit 601 includes a first scan switching device SC1 and a second scan switching device SC2 that are serially connected to each other. A fourth node N4 between the first and second scan switching device SC1 and SC2 is connected to the Y electrodes, namely, the second end of the display panel Cp. The scan switching unit 601 may be made up of scan ICs that can control the application of power to the Y electrode lines. The Y electrode lines are divided into a plurality of blocks. The scan switching unit 601 may be made up of a plurality of scan ICs so that a scan IC is connected to each of the blocks.

The fifth voltage applying unit 603 includes a fifth voltage source Vsch and is connected to the first scan switching device SC1 in order to output a fifth voltage Vsch to the first scan switching device SC1. The sixth voltage applying unit 615 is connected to the third node N3 and the second scan switching device SC2 and outputs a sixth voltage Vsc1 to the third node N3 and the second scan switching device SC2.

The energy collecting unit 620 provides charges to the display panel Cp so that the charges are accumulated within the display panel Cp, or receives charges from the display panel Cp and stores the same therein.

The first voltage applying unit 611 includes an eighth switching device S8 with one end connected to a first voltage source Vs and the other end connected to the first node N1. The ground voltage applying unit 612 includes a ninth switching device S9 with one end grounded and the other end connected to the first node N1. In the sustain pulse applying unit 610 including the first voltage applying unit 611 and the ground voltage applying unit 612, the eighth and ninth switching devices S8 and S9 are alternately turned on in order to generate sustain pulses.

The third voltage applying unit 607 includes a fourth capacitor C4 and a tenth switching device S10. The fourth capacitor C4 has one end connected to the first node N1 and the other end connected to a third voltage source Vset. The tenth switching device S10 is connected between the third voltage source Vset and the second node N2.

The fourth voltage applying unit 609 includes an eleventh switching device S11 with one end connected to the third node N3 and the other end connected to a fourth voltage source Vnf The eighth switching device S8 of the first voltage applying unit 611, the seventh switching device S7 of the first switching unit 605, the fifteenth switching device S15 of the second switching unit 617, and the eleventh switching device S11 of the fourth voltage applying unit 609 are turned on, so that a voltage gradually falling from the first voltage Vs to the fourth voltage Vnf is output to the third node N3.

The sixth voltage applying unit 615 includes a twelfth switching device S12 connected between the third node N3 and a sixth voltage source Vsc1. The twelfth switching device S12 is turned on in order to output a sixth voltage Vsc1 to the third node N2.

When the first scan switching device SC1 of the scan switching unit 601 is turned on and the second scan switching device SC2 thereof is turned off, the fifth voltage Vsch is output to the Y electrodes (i.e., the second end of the display panel Cp) via the fourth node N4. When the first scan switching device SC1 of the scan switching unit 601 is turned off and the second scan switching device SC2 thereof is turned on, voltages output to the third node N3, namely, the first voltage Vs, the ground voltage Vg, the fourth voltage Vnf, and the sixth voltage Vsc1, are output to the Y electrodes (i.e., the second end of the display panel Cp) via the fourth node N4.

The energy collection unit 620 includes an energy storage unit 621, an energy collection switching unit 622, and an inductor L2. The energy storage unit 621 stores charges existing within the display panel Cp. The energy collection switching unit 622 is connected to the energy storage unit 621 and controls the charges stored in the energy storage unit 621 to be accumulated within the display panel Cp or the charges within the display panel Cp to be stored in the energy storage unit 621. The inductor L2 has one end connected to the energy collection switching unit 622 and the other end connected to the first node N1.

The energy storage unit 621 includes a capacitor C5 to store charges existing within the display panel Cp. The energy collection switching unit 622 includes a thirteenth switching device S13 and a fourteenth switching device S14, each having one end connected to the energy storage unit 621 and the other end connected to the inductor L2. A third diode D3 and a fourth diode D4 that have different directions may be connected between the thirteenth and fourteenth switching devices S13 and S14.

The inductor L2 includes a first inductor L21, a second inductor L22, and a control switch S60. The first and second inductors L21 and L22 are serially connected to each other. The control switch S60 is connected between both ends of the first or second inductor L21 or L22 so as to be parallel to one of the first and second inductors L21 and L22. In one embodiment, the control switch S60 is connected between both ends of the second inductor L22.

Accordingly, when the control switch S60 is turned on, both ends of the second inductor L22 is shorted, so that the inductor L2 has an effect that only the first inductor L21 is connected to the energy collection switching unit 622. When the control switch S60 is turned off, the inductor L2 has an effect of a single inductor having an inductance based on a serial connection between the first and second inductors L21 and L22.

A period of a resonance current flowing through an inductor is proportional to the inductance of the inductor. Accordingly, when the control switch S60 is turned off, the inductance of the inductor L2 is a sum of the first and second inductors L21 and L22, so that the rising time increases.

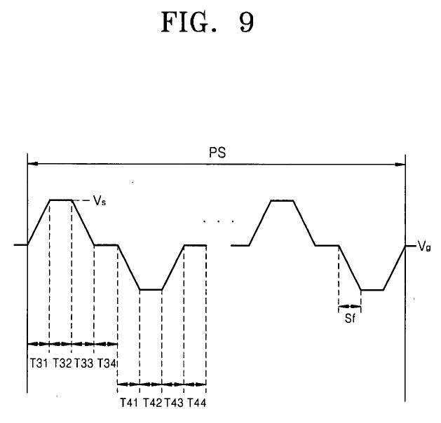

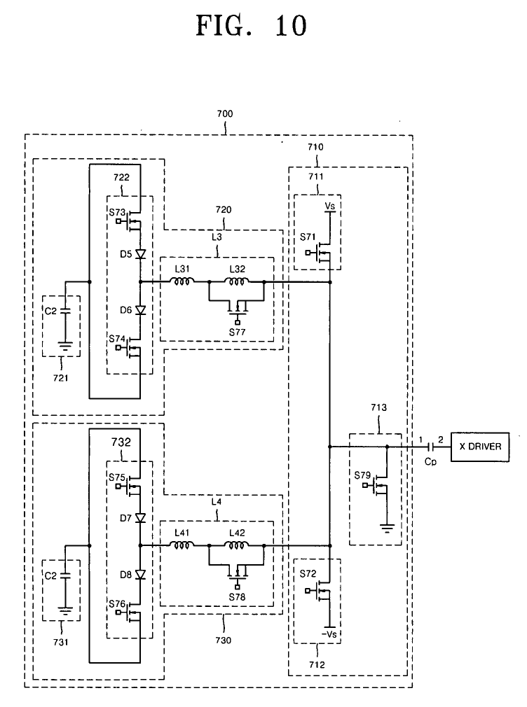

FIG. 8 is a timing diagram of another embodiment of driving signals that are output by driving units shown in FIG. 2. FIG. 9 is a schematic timing diagram of sustain pulses in the driving signal of FIG. 9 that are applied during a sustain discharge period.

Referring to FIGS. 8 and 9, a method of driving a PDP according to an embodiment may be applied to a display panel in which discharge cells are formed in regions where sustain electrode lines intersect address electrode lines. The PDP driving method according to one embodiment may, for example, be applied to the 3-electrode PDP of FIG. 3 and also to a 2-electrode PDP in which one group of electrodes serve as address electrodes and the other group of electrodes serve as scan electrodes and sustain electrodes.

In one embodiment, a frame is divided into a plurality of subfields SFs depending on a gray level weight for driving time-division gray level display. Each of the subfields SFs is divided into a reset period PR, an addressing period PA, and a sustain period PS.

During the reset period PR, the discharge cells are initialized. During the addressing period PA, discharge cells which are to display images are selected from among the display cells. During the sustain period PS, sustain discharge is generated in the selected discharge cells by sustain pulses, the number of which depends on the gray level weight.

The PDP driving method according to the present embodiment is similar to that illustrated in FIG. 3. In this embodiment, a sustain discharge period PS is different.

During the sustain discharge period PS, a rising sustain pulse having a second level voltage Vs, and a falling sustain pulse having a third level voltage −Vs are alternately applied to each of sustain electrode lines, namely, either the X electrode lines X1 through Xn or the Y electrode lines Y1 through Yn. The rising and/or falling time of at least one finishing sustain pulse applied at the end of the sustain discharge period from among the sustain pulses is greater than that of the remaining sustain pulses.

In one embodiment, one sustain pulse last applied in each subfield from among the sustain pulses is the finishing sustain pulse. In another embodiment, two or more sustain pulses may be the finishing sustain pulses. In other words, the finishing sustain pulse may be a falling sustain pulse having the third level voltage −Vs.

In this embodiment, the length Sf of a falling interval of the finishing sustain pulse is greater than those of the falling intervals of the sustain pulses other than the finishing sustain pulse in each subfield.

The rising sustain pulse includes a rising time T31 during which its voltage rises from the first level Vg to the second level Vs, a first sustain time T32 during which the voltage sustains the second level Vs, a falling time T33 during which the voltage falls from the second level Vs to the first level Vg, and a second sustain time T34 during which the voltage sustains the first level Vg.

The falling sustain pulse includes a falling time T41 during which its voltage falls from the first level Vg to the third level −Vs, a third sustain time T42 during which the voltage sustains the third level −Vs, a rising time T43 during which the voltage rises from the third level −Vs to the first level Vg, and a fourth sustain time T44 during which the voltage sustains the first level Vg.

The second sustain time T34 may be overlapped by the third sustain time T42. The first level may be a ground level Vg, the second level may be a positive level +Vs, and the third level may be a negative level −Vs.

According to some embodiments, the amount and peak value of light within the subfield are reduced. In particular, the amount and peak value of light of the last sustain pulse are reduced. As a result, the influence between adjacent subfields or adjacent frames is reduced. Thus, appearance of afterimages is reduced, and the quality of an image displayed by a PDP is improved.

FIG. 10 is a circuit diagram schematically illustrating an apparatus 700 for driving a PDP according to the driving method illustrated in FIGS. 8 and 9. Referring to FIG. 10, the PDP driving apparatus 700 includes a sustain driving unit 710, a first energy collecting unit 720, and a second energy collecting unit 730. The PDP driving apparatus 700 drives a PDP according to the driving method illustrated in FIGS. 8 and 9.

The first energy collecting unit 720 includes an energy storage unit 721, an energy collection switching unit 722, and an inductor L3. The energy storage unit 721 collects charges from a first voltage supply terminal Vs and from a panel Cp. The energy collection switching unit 722 controls the charges stored in the energy storage unit 721 to be accumulated within the display panel Cp. The inductor L3 has one end connected to the energy collection switching unit 722 and the other end connected to the display panel Cp.

The inductor L3 includes a first inductor L31, a second inductor L32, and a control switch S77. The first and second inductors L31 and L32 are serially connected to each other. The control switch S77 is connected between both ends of the first or second inductor L31 or L32 so as to be parallel to one of the first and second inductors L31 and L32. In one embodiment, the control switch S77 is connected between both ends of the second inductor L32.

Accordingly, when the control switch S77 is turned on, the second inductor L32 is shorted, so that the inductor L3 has an effect of only the first inductor L31 being connected to the energy collection switching unit 722. When the control switch S77 is turned off, the inductor L3 has an effect of a single inductor having an inductance value of a serial connection between the first and second inductors L31 and L32.

A period of a resonance current flowing through an inductor is proportional to the inductance of the inductor. Accordingly, when the control switch S77 is turned off, the inductance of the inductor L3 is a sum of the first and second inductors L31 and L32, so that the rising time increases.

The second energy collecting unit 730 includes an energy storage unit 731, an energy collection switching unit 732, and an inductor L4. The energy storage unit 731 collects charges from a second voltage supply terminal −Vs and from the display panel Cp The energy collection switching unit 732 controls the charges stored in the energy storage unit 731 to be accumulated within the display panel Cp. The inductor L4 has one end connected to the energy collection switching unit 732 and the other end connected to the display panel Cp.

The inductor L4 includes a first inductor L41, a second inductor L42, and a control switch S78. The first and second inductors L41 and L42 are serially connected to each other. The control switch S78 is connected between both ends of the first or second inductor L41 or L42 so as to be parallel to one of the first and second inductors L41 and L42. In one present embodiment, the control switch S78 is connected between both ends of the second inductor L42.

Accordingly, when the control switch S78 is turned on, the second inductor L42 is shorted, so that the inductor L4 has an effect of only the first inductor L41 being connected to the energy collection switching unit 732. When the control switch S78 is turned off, the inductor L4 has an effect of a single inductor having an inductance value of a serial connection between the first and second inductors L41 and L42.

A period of a resonance current flowing through an inductor is proportional to the inductance of the inductor. Accordingly, when the control switch S78 is turned off, the inductance of the inductor L4 is a sum of the first and second inductors L41 and L42, so that the rising time increases.

The sustain driving unit 710 includes a first voltage applying unit 711, a second voltage applying unit 712, and a ground voltage applying unit 713. The first voltage applying unit 711 controls the application of the second level voltage Vs, the second voltage applying unit 712 controls the application of the third level voltage −Vs, and the ground voltage applying unit 713 controls the application of the first level voltage Vg.

The first voltage applying unit 711 includes a third control switch S71 with one end connected to the first voltage supply terminal Vs and the other end connected to the display panel Cp. The second voltage applying unit 712 includes a fourth control switch S72 with one end connected to a second voltage supply terminal −Vs and the other end connected to the display panel Cp. The ground voltage applying unit 713 includes a control switch S79 with one end grounded and the other end connected to the display panel Cp.

In some embodiments, powers supplied by the first and second voltage supply terminals Vs and −Vs have the same size and opposite polarities.

During the falling edge Sf of the sustain pulse, the first control switch S75 of the second energy collecting unit 730 is first turned on and, after a predetermined time interval, the fourth control switch S72 is then turned on. The time interval of the finishing sustain pulse is greater than the time interval in sustain pulses other than the finishing sustain pulse.

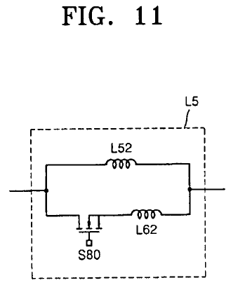

FIG. 11 is a schematic diagram of an inductor circuit (or pulse length adjustment circuit) which can be applied to FIGS. 6, 7 and 10 according to another embodiment. Referring to FIG. 11, the inductor circuit L5 includes inductors (or inductive loads) L52 and L62, and a control switch S80. In this embodiment, the inductors L52 and L62 are connected in parallel to each other. Furthermore, the switch S80 is connected in series to one of the two inductors L52 and L62 (L62 in FIG. 11).

When the control switch S80 is turned on, the inductor L5 has a first inductance value of a parallel connection between the inductors L52 and L62. When the control switch S77 is turned off, the inductor L5 has a second inductance value of only the inductor L52. If the values of L52 and L62 are determined so that the first and second inductance values are different, the pulse length adjustment can be achieved.

In an apparatus and method of driving a PDP according to some embodiments, the rising or falling time of the last one or several sustain pulse(s) from among sustain pulses applied to sustain electrodes during a sustain discharge period of one or more subfields is adjusted to be greater than those of the other sustain pulses, thereby reducing the appearance of an afterimage. While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. An apparatus for driving a plasma display panel, comprising:
first and second electrodes configured to generate a sustain discharge in a frame which includes a plurality of subfields; and
a driver configured to provide a series of driving pulses to at least one of the first and second electrodes in at least one of the plurality of subfields, wherein at least the last one of the series of driving pulses has a greater rising and/or falling time than those of the remaining driving pulses.

2. The apparatus of claim 1, wherein the driver includes a pulse length adjustment circuit configured to lengthen a rising and/or falling time of the at least last one of the series of driving pulses so as to produce the greater rising and/or falling time.

3. The apparatus of claim 2, wherein the pulse length adjustment circuit includes i) a pair of inductors which have different inductances and ii) a switch configured to increase or decrease a nominal inductance of the combination of the pair of inductors.

4. The apparatus of claim 3, wherein the inductors are connected to each other in series, and wherein the switch is connected in parallel to one of the inductors.

5. The apparatus of claim 3, wherein the inductors are connected to each other in parallel, and wherein the switch is connected in series to only one of the inductors.

6. An apparatus for driving a plasma display panel (PDP), comprising:
a driver configured to drive the PDP and including first and second current paths, wherein the first and second current paths include first and second inductive loads, respectively, wherein the first and second inductive loads are different from each other, and wherein the first and second inductive loads are electrically connected to each other.

7. The apparatus of claim 6, wherein the first and second inductive loads are connected to each other in series.

8. The apparatus of claim 6, wherein the first and second inductive loads are connected to each other in parallel.

9. The apparatus of claim 6, wherein the first and second current paths are connected to a single conductive load.

10. The apparatus of claim 9, wherein the single conductive load is an energy storing capacitor.

11. The apparatus of claim 6, further comprising a switch configured to open and close one of the first and second current paths.

12. The apparatus of claim 11, wherein the switch is connected to only one of the inductive loads.

13. A method of driving a plasma display panel, comprising:
generating at least one first driving pulse having a first rising and/or falling time;
generating at least one second driving pulse having a second rising and/or falling time which is longer than the first rising and/or falling time; and
driving the PDP panel in a subfield of a frame with the combination of the first and second driving pulses.

14. The method of claim 13, wherein the at least one second driving pulse immediately follows the at least one first driving pulse.

15. The method of claim 13, wherein the at least one second driving pulse is a single driving pulse.

16. The method of claim 13, wherein the subfield includes all of the subfields of the frame.

17. The method of claim 13, wherein the driving pulses are sustain pulses applied during a sustain discharge period.
